(19) United States
(12) Patent Application Publication
(10) Pub. No.: US 2018/0283099 A1
(43) Pub. Date: Oct. 4, 2018

(54) COMMAND AND CONFIRM ELECTRONIC SHUTTER SYSTEMS

(71) Applicant: Cooper Windows LLC, Pawcatuck, CT (US)

(72) Inventors: Brian Cooper, North Stonington, CT (US); Robert Cooper, North Stonington, CT (US); Joseph Colangelo, Willington, CT (US); Ethan Cooper, North Stonington, CT (US)

(21) Appl. No.: 15/939,593

(22) Filed: Mar. 29, 2018

Related U.S. Application Data
(60) Provisional application No. 62/478,065, filed on Mar. 29, 2017.

(51) Int. Cl. E06B 9/68; G05B 15/02

(52) U.S. Cl. CPC E06B 9/68; G05B 15/02

(57) ABSTRACT

Electronic shutter systems having an electronic shutter, a shutter controller configured in communication with the electronic shutter and configured to receive instructions from one or more user devices, a shutter sensor associated with the electronic shutter and configured to detect a state of the electronic shutter, wherein the shutter sensor is in communication with the shutter controller. The shutter controller is configured to transmit a state command to the electronic shutter upon receiving instructions from a user device, start a timer upon transmitting the state command, determine if a state of the electronic shutter matches the state command at expiration of the timer, when the state does not match the state command, generate a state failure message, and transmit the state failure message to the user device.

### CROSS-REFERENCE TO RELATED APPLICATIONS

The present application claims priority from U.S. Provisional Patent Application No. 62/478,065, filed Mar. 29, 2017. The contents of the priority application is hereby incorporated by reference in its entirety.

### BACKGROUND

The subject matter disclosed herein generally relates to window shutter systems and, more particularly, to command and confirm operation systems for window shutters.

Electronic shutters can be provided to enable a user to have easy access to deploy and/or retract shutters from covering and protecting windows of a building. The electronic shutters can be electromechanical devices that can operate based upon command signals received from a control device. Although electronic shutters have provided many quality of life improvements to home owners and other users, various improvements may be implemented to provide further advantages to such electronic shutters.

### SUMMARY

According to some embodiments, electronic shutter systems are provided. The electronic shutter systems include an electronic shutter, a shutter controller configured in communication with the electronic shutter and configured to receive instructions from one or more user devices, and a shutter sensor associated with the electronic shutter and configured to detect a state of the electronic shutter, wherein the shutter sensor is in communication with the shutter controller. The shutter controller is configured to transmit a state command to the electronic shutter upon receiving instructions from a user device, start a timer upon transmitting the state command, determine if a state of the electronic shutter matches the state command at expiration of the timer, when the state does not match the state command, generate a state failure message, and transmit the state failure message to the user device.

In addition to one or more of the features described herein, or as an alternative, further embodiments of the electronic shutter systems may include that the shutter sensor comprises a first switching element located proximate the electronic shutter and a second switching element fixed to the electronic shutter and movable therewith, wherein when the second switching element is in proximity to the first switching element, a signal is generated.

In addition to one or more of the features described herein, or as an alternative, further embodiments of the electronic shutter systems may include that the first and second switching elements are magnets.

In addition to one or more of the features described herein, or as an alternative, further embodiments of the electronic shutter systems may include that the electronic shutter is in wireless communication with the shutter controller.

In addition to one or more of the features described herein, or as an alternative, further embodiments of the electronic shutter systems may include that the shutter controller is further configured to generate a state success message when the state matches the state command and transmit the state success message to the user device.

According to some embodiments, command and confirm shutter systems are provided. The command and confirm shutter systems include a first electronic shutter, a second electronic shutter, a shutter controller configured in communication with the first and second electronic shutters and configured to receive instructions from one or more user devices, a first shutter sensor associated with the first electronic shutter and configured to detect a state of the first electronic shutter, wherein the first shutter sensor is in communication with the shutter controller, and a second shutter sensor associated with the second electronic shutter and configured to detect a state of the second electronic shutter, wherein the second shutter sensor is in communication with the shutter controller. The shutter controller is configured to transmit a state command to at least one of the first and second electronic shutters upon receiving instructions from a user device, start a timer upon transmitting the state command, determine if a state of the respective electronic shutter matches the state command at expiration of the timer, when the state does not match the state command, generate a state failure message, and transmit the state failure message to the user device.

In addition to one or more of the features described herein, or as an alternative, further embodiments of the command and confirm shutter systems may include that the first shutter sensor comprises a first switching element located proximate the electronic shutter and a second switching element fixed to the first electronic shutter and movable therewith, wherein when the second switching element is in proximity to the first switching element, a signal is generated.

In addition to one or more of the features described herein, or as an alternative, further embodiments of the command and confirm shutter systems may include that the first and second switching elements are magnets.

In addition to one or more of the features described herein, or as an alternative, further embodiments of the command and confirm shutter systems may include that the first electronic shutter is in wireless communication with the shutter controller and the second electronic shutter is in wired communication with the shutter controller.

In addition to one or more of the features described herein, or as an alternative, further embodiments of the command and confirm shutter systems may include that the shutter controller is further configured to generate a state success message when the state matches the state command and transmit the state success message to the user device.

In addition to one or more of the features described herein, or as an alternative, further embodiments of the command and confirm shutter systems may include a first power supply in electrical communication with the first electronic shutter and a second power supply in electrical communication with the second electronic shutter.

In addition to one or more of the features described herein, or as an alternative, further embodiments of the command and confirm shutter systems may include that the first power supply is a battery and the second power supply is grid power.

In addition to one or more of the features described herein, or as an alternative, further embodiments of the command and confirm shutter systems may include a user device configured to communicate with the shutter controller.

In addition to one or more of the features described herein, or as an alternative, further embodiments of the command and confirm shutter systems may include that the timer is based on a state change operation of at least one of the first and second electronic shutters.

Technical effects of embodiments of the present disclosure include shutter systems that are electronically controlled enabling command and confirm operations to be performed with respect to the shutters. Technical effects include the ability to transmit a command from a user device to the shutter system, perform an operation of the shutters in response to the command, and further to identify operation of the shutters and to transmit a confirmation notice to the user device.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a perspective view of a window that may employ embodiments described herein;

FIG. 2 is a schematic illustration of a command and confirm shutter system in accordance with the present disclosure;

FIG. 3 is a schematic illustration of a system in accordance with an embodiment of the present disclosure;

FIG. 4A is a schematic illustration of a computing system of a user device in accordance with an embodiment of the present disclosure;

FIG. 4B is a schematic illustration of a computing system of a controller in accordance with an embodiment of the present disclosure;

FIG. 5 is a flow process for providing command and confirm capability with electronic shutter systems in accordance with the present disclosure;

FIG. 6A is a schematic illustration of an electronic shutter system in accordance with an embodiment of the present disclosure; and

FIG. 6B is an enlarged illustration of a shutter sensor of the electronic shutter system of FIG. 6A in accordance with an embodiment of the present disclosure.

FIG. 7A is a schematic illustration of an electronic shutter system in a deployed state, with a partial internal view of components thereof, in accordance with an embodiment of the present disclosure;

FIG. 7B is an alternative view of the electronic shutter system of FIG. 7A shown in the deployed state;

FIG. 7C is an enlarged illustration of a portion of the electronic shutter system of FIG. 7A in the deployed state;

FIG. 7D is another illustration of a portion of the electronic shutter system of FIG. 7A in the deployed state;

FIG. 7E is a schematic illustration of the electronic shutter system of FIG. 7A in a retracted or stowed state; and

FIG. 7F is an enlarged illustration of a portion of the electronic shutter system of FIG. 7A in the retracted state.

### DETAILED DESCRIPTION

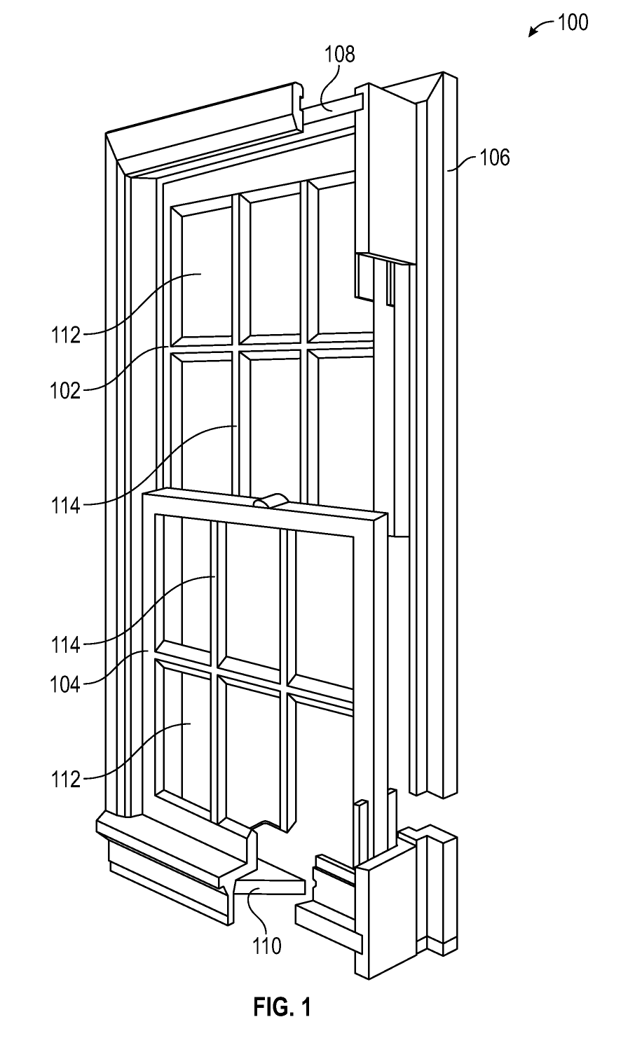

FIG. 1 is a partial schematic illustration of a window 100 that may employ embodiments described herein. The window 100 includes a first or upper sash 102 and a second or lower sash 104. Each sash 102, 104 may be configured to move (e.g., slide or translate) within a frame 106. The frame 106 may include guides (not shown) to enable movement of the sashes 102, 104 within the frame 106. The top of the frame 106, as shown, is configured having a jamb 108 that stops or prevents the sashes 102, 104 from moving above a specific height or level. Similarly, the bottom of the frame 106, as shown, is configured as having a sill 110. The sill 110 defines a lower limit of the movement of the sashes 102, 104 within the frame 106. The guides of the frame 106 can extend through or along at least a portion of the frame 106 that extends vertically between the sill 110 and the jamb 108. The frame 106, in some configurations, can be configured to be installed and fit within a wall of a structure (not shown), such as a house, building, etc.

Each sash 102, 104, as shown, includes one or more sash lights 112. Sash lights 112, as used herein, are one or more glass or other material panes that are installed within the window 100. In the window 100, shown in FIG. 1, muntins 114 are provided to support the sash lights 112 within each sash 102, 104. The muntins 114 may be configured as bars or rigid supporting strip or structures that are positioned between adjacent panes of glass or other material (e.g., adjacent sash lights 112). In some embodiments, the muntins 114 can be merely aesthetic, with a single large sash light 112 within the first and second sashes 102, 104, i.e., a single pane of glass or other material is fit within the respective sashes 102, 104.

It may be beneficial to protect the sash lights 112 and the other structures and/or features of the window 100. For example, in historic structures, maintaining the character of the windows may be desired, and thus protecting the windows (e.g., sash lights, muntins, etc.) from damage may be beneficial. One method for protecting windows can be by providing a shutter or other device that covers the window in the event of weather phenomena, such as storms, hurricanes, tornados, hails, etc.

Shutters may be electronically controlled to enable remote control of a shutter operation (e.g., close one or more shutters in a single instance). Advantageously, such system can enable remote operation when a user is not physically located at a particular location. Further, electronic systems can enable ease of use and improve efficiency of shutters. As provided herein, systems and processes for enabling command and confirmation regarding operation of electronic shutter systems are provided.

Embodiments provided herein are directed to control systems that allow for operation of motorized window shutters, both onsite and offsite, of a given property and enabling monitoring of operation each shutter for its open or close position.

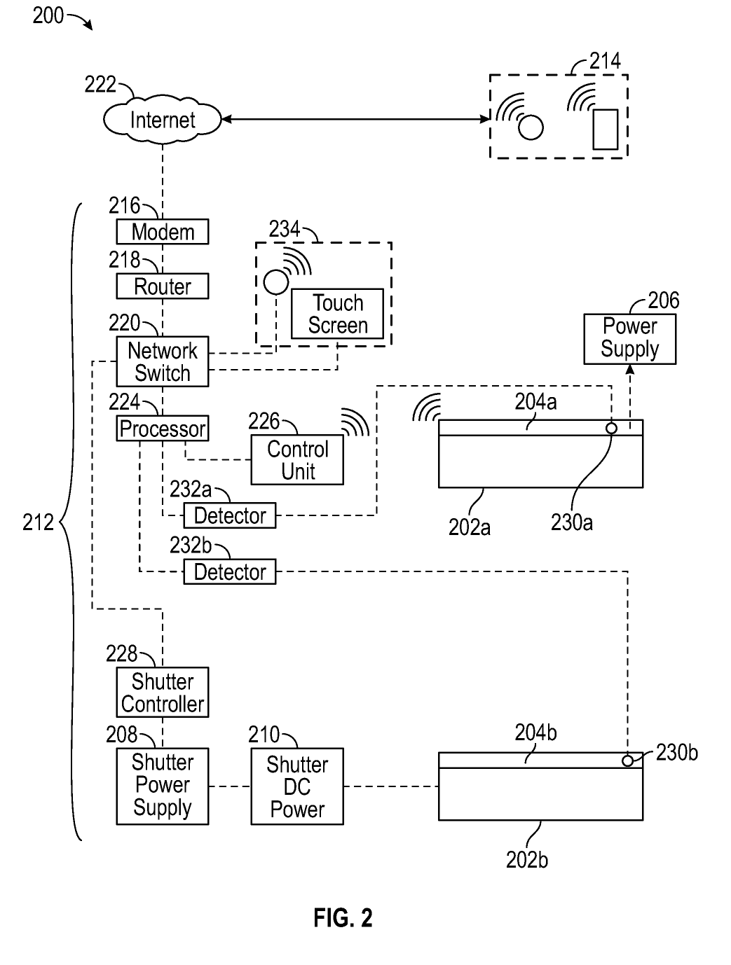

Turning to FIG. 2, a schematic block diagram of a command and confirm shutter system 200 is shown. The command and confirm shutter system 200 is associated with one or more windows 202a, 202b that have respective electronic shutters 204a, 204b. As schematically shown, a first window 202a includes a wireless electronic shutter 204a and a second window 202b includes a wired electronic shutter 204b. The electronic shutters 204a, 204b are powered by associated power supply systems. For example, the wireless electronic shutter 204a is powered by a first power supply 206 and the wired electronic shutter 204b is powered by a second power supply 208. In one non-limiting example, the first power supply 206 can provide DC power to the wireless electronic shutter 204a, such as in the form of a battery or battery pack, and the second power supply 208 can provide AC power to a DC converter 210 and thus to the wired electronic shutter 204b, such as in the form of grid power. In some embodiments, the first and second power supplies 206, 208 are the same source, and associated components may be included and/or eliminated as necessary for the particular power supply configuration.

The command and confirm shutter system 200 includes a shutter control system 212, which may include the power supplies 206, 208 and control thereof. The shutter control system 212 is able to be in communication with one or more remote (e.g., user) access devices 214. The remote access devices 214 can send instructions and/or commands to the shutter control system 212 to initiate activation and/or operation of one or more shutters of the shutter control system 212, including, but not limited to the electronic shutters 204a, 204b shown in FIG. 2.

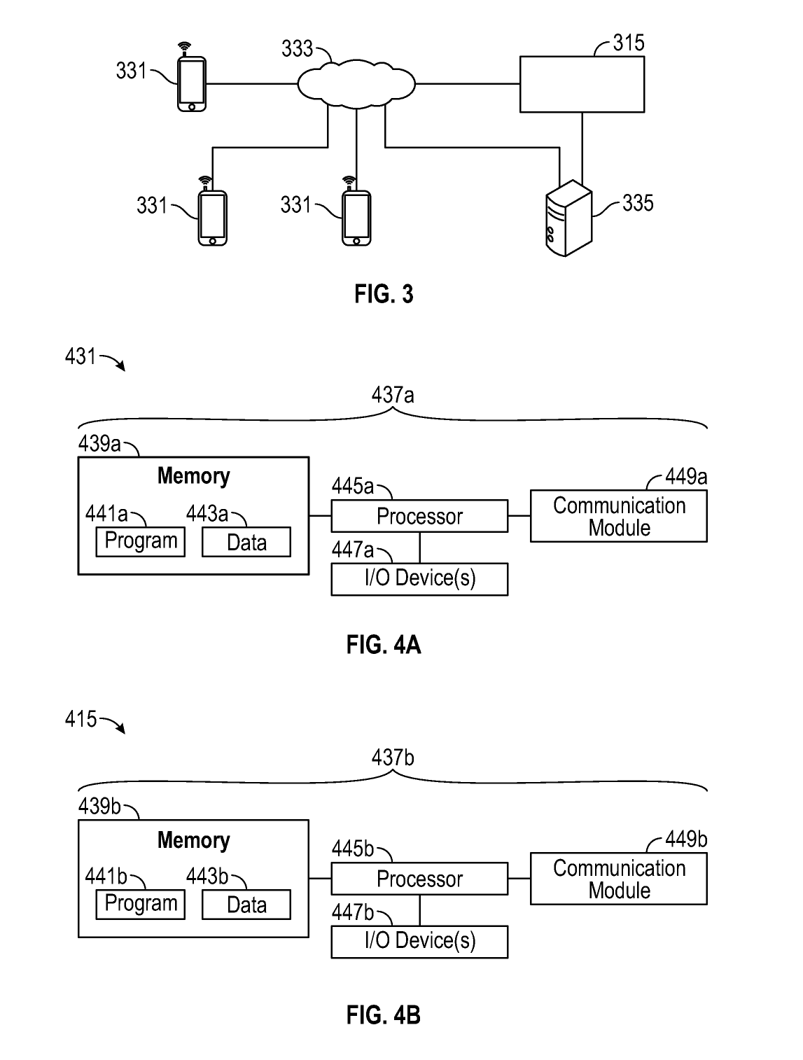

To enable communication, the shutter control system 212 includes various communication elements, including, but not limited to, a modem 216, a router 218, and a network switch 220. The communication elements 216, 218, 220 can enable wired and/or wireless communication between the shutter control system 212 and the remote access devices 214, as described herein (e.g., with respect to FIG. 3). The communication between the shutter control system 212 and the remote access devices 214 can be over and/or through the internet 222 or other network communication system/protocol.

The network switch 220 enables communication control and commands to be directed in and through the shutter control system 212 over wired or wireless communication lines. The network switch 220 can enable commands to be processed and transmitted to appropriate components as described herein.

The shutter control system 212 includes a shutter controller 224, having a processor, to enable processing of requests, commands, etc. and also to perform execution of various tasks, such as transmitting command instructions or signals to the electronic shutters 204a, 204b. The shutter controller 224 can transmit commands, instructions, and/or signals directly to one or more components and/or can transmit instructions and/or signals through the network switch 220, with the instructions and/or signals being routed to an appropriate destination. As shown, the shutter control system 212 includes a wireless shutter control unit 226 and a wired shutter control unit 228 (although in some embodiments a single shutter control unit can be configured to control one or more shutters).

The electronic shutters 204a, 204b can be monitored for status or state (e.g., open or closed) using a respective sensor. For example, as shown, a first shutter sensor 230a is arranged with the wireless electronic shutter 204a and a second shutter sensor 230b is arranged with the wired electronic shutter 204b. The shutter sensors 230a, 230b are selected and positioned to be able to detect an open or closed state of the associated electronic shutter. The shutters sensors 230a, 230b in accordance with the present disclosure are electromagnetic sensors that employ a permanent or rare Earth magnet affixed to a portion of the shutter and a sensor/detector fixed within a header or other location such that a signal or trigger is generated when the magnet is in proximity to the detector. Each of the shutter sensors 230a, 230b has an associated sensor detector 232a, 232b that is configured to determine the state observed/detected by the respective shutter sensor 230a, 230b. For example, in some configurations, the sensor detector 232a, 232b can monitor an electrical current associated with the respective shutter sensor 230a, 230b, and when a particular criteria is met, the sensor detector 232a, 232b can send an appropriate signal or message to the shutter controller 224 to indicate a shutter state (open/closed/etc.) which can be based, in part, on the configuration and selection of sensor detector and/or shutter sensor. In some embodiments, the shutter sensor and sensor detector are configured within a single unitary both and/or electrical component.

In addition to providing remote access/control of the shutter control system 212, local access and/or control can be enabled using local access device 234. The local access devices 234 can include one or more user electronic components, such as computers, touch screens, voice activated devices, remote controllers, home automation systems, etc.

In operation, onsite control is done with access to the shutter control system 212 through the network switch 220 using a remote access device 214 and/or a local access device 234. The remote access device 214 and/or the local access device 234 can include appropriate applications and/or software to enable communication with and control of the shutter control system 212. In some embodiments, the local access device 234 can be an appropriate touchscreen, computer, or other device connected to the local system (e.g., onsite). Offsite control can be achieved through the internet 222, through a connection to the shutter controller 224 that is onsite, using a smartphone, tablet, or computer.

The shutter controller 224 can manage any number of electronic shutters (generically “electronic shutters 204”) associated with any number of windows. The shutter control system 212 and the shutter controller 224 thereof can enable directed or addressable control to enable one or more electronic shutters of a system to be controlled as a subgroup or even individually or alternatively all connected electronic shutters can be operated simultaneously. The shutter controller 224 talks to a respective shutter control unit 226, 228 using an appropriate communication protocol depending on the type of shutter controller used (e.g., internet, wired, wireless, etc.). The electronic shutters 204 can be controlled with “send and receive” capabilities. The shutter controller 224 and shutter control unit 226, 228 can share communication protocols allowing for seamless integration of the systems.

The shutter controller 224 is given a state command by onsite or offsite devices 214, 234. The state command is then sent to the respective shutter control unit 226, 228, which instructs the associated electronic shutter 204 to enter a specific state (e.g., such as open or close). The shutter sensors (generically “shutter sensors 230”) and sensor detectors (generically “sensor detectors 232”) can determine if the associated shutter has changed state (e.g., moved from open to close or vice versa) or is already in the appropriate state.

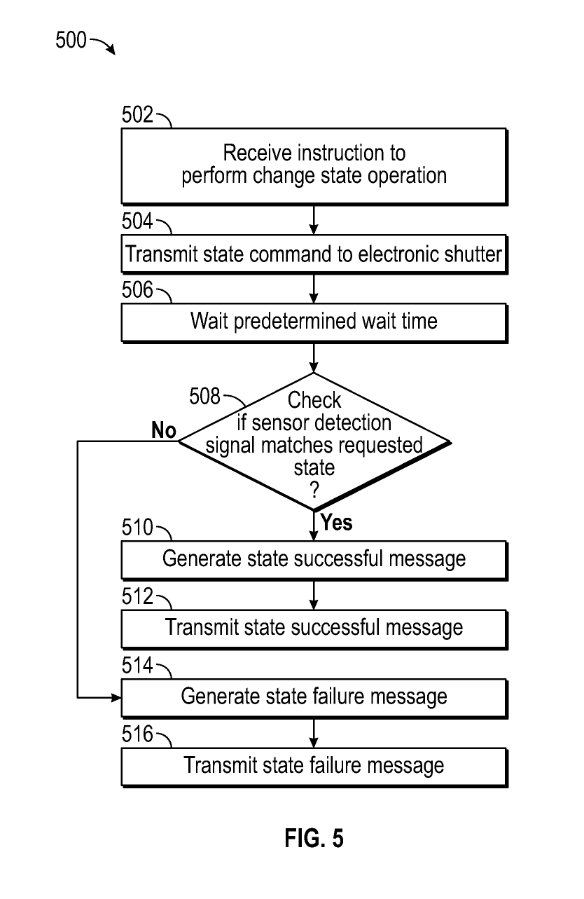

For example, if a user requests a “close” operation, and that position is not achieved within a given time period for a specific electronic shutter 204, a signal can be sent to the shutter controller 224 which generates a “pop message” regarding the given electronic shutter 204. The process may be provided and controlled by a preprogrammed “event map” (see, e.g., FIG. 5) that is stored within the shutter controller 224 or associated memory (e.g., as shown and described with respect to FIGS. 4A-4B). The event map is composed of conditional logic which is initiated by a state change operation request (e.g., request or command sent from a device 214, 234).

Once the request or command is sent, and the appropriate instructions are sent to an indicated electronic shutter 204, a timer at the shutter controller 224 is started. The timer can be a predetermined or preset waiting period to enable the appropriate operation to be physically performed at the electronic shutter (e.g., movement upward or downward). The sensor detector 232 determines if the state of the shutter sensor 230 as changed (e.g., a normally open electromechanical switch has closed). At the end of the time period, the shutter controller 224 can query the appropriate sensor detector 232 to determine if an appropriate state is present (e.g., if sent “close” instruction, does sensor detector indicate the electronic shutter is closed). If no such confirmation is achieved at the shutter controller 224, a notification or message, such as a “pop message,” is sent to the appropriate end user (e.g., at the device 214, 234).

In some embodiments, the shutter controller 224 can be programmed and tested offsite by a trained technician with the appropriate software. The shutter controller 224 can enable control and/or be integrated with other types of systems such as alarm systems, surveillance systems, lighting systems, heating/ventilation/air conditioning (“HVAC”) systems, media systems, phone messaging systems, irrigation systems, and/or pool control systems. Surveillance and lighting systems may allow an offsite user to see the property, view the shutters, and turn on lighting if necessary depending on local light levels. The shutter controller 224 can also be connected to a local weather notification system (e.g., through the internet 222). Monitoring the weather can enable the shutter control system 212 to respond automatically to preset or predetermined conditions associated therewith. For example, a variable in the shutter control system 212 (e.g., the shutter controller 224) can enable triggering of the shutter control system 212 to generate state command instructions to operate one or more electronic shutters 204. Such instructions can automatically have the electronic shutters 204 to move to a predetermined desired position based on the input variables (e.g., weather conditions) and or generate an alert to be sent to a user of the device 214.

As noted above, the shutter control system 212 and/or the shutter controller 224 can include electronics that include processor(s), memory, communication module(s), etc. as shown and described herein. User devices can be employed within and with aspects and embodiments of the present disclosure. The user devices can include mobile devices, computers, tablets, smartphones, etc. The user devices can communicate with one or more system components, such as computers, controllers, etc. The system components can include processors, memory, communications modules, etc. The communication between the user devices and the system components can be by wired or wireless communication, through the internet, direct connection, etc. as will be appreciated by those of skill in the art.

A user device and a controller in accordance with embodiments of the present disclosure can communicate with one another, e.g., as shown in FIG. 3. For example, one or more user devices 331 (e.g., remote access devices 214 and/or local access device 234 shown in FIG. 2) and the controller 315 (e.g., shutter control system 212) may communicate with one another when proximate to one another (e.g., within a threshold distance) and/or through network communication, as schematically shown. The user device 331 and the controller 315 may communicate over a network 333, that may be wired or wireless. Wireless communication networks can include, but are not limited to, Wi-Fi, short-range radio (e.g., Bluetooth®), near-field infrared, cellular network, etc. In some embodiments, the controller 315 may include, or be associated with (e.g., communicatively coupled to) one or more networked system elements 335, such as computers, routers, network nodes, etc. The networked system element 335 may also communicate directly or indirectly with the user devices 331 using one or more communication protocols or standards (e.g., through the network 333).

For example, the networked system element 335 can communicate with the user devices 331 using near-field communications (NFC) (e.g., network 333) and thus enable communication between the user devices 331 and the controller 315. In some embodiments, the controller 315 may establish communication with one or more user devices 331 that are outside of a structure or building. Such connection can be established with various technologies including GPS, triangulation, or signal strength detection, by way of non-limiting example. Such technologies that allow communication can provide users and the system(s) described herein time to perform the described functions. In example embodiments, the user devices 331 communicate with the controller 315 over multiple independent wired and/or wireless networks. Embodiments are intended to cover a wide variety of types of communication between the user devices 331 and the controller 315, and embodiments are not limited to the examples provided in this disclosure.

The network 333 may be any type of known communication network including, but not limited to, wide area networks (WAN), local area networks (LAN), global networks (e.g. Internet), virtual private networks (VPN), cloud networks, intranet, etc. The network 333 may be implemented using a wireless network or any kind of physical network implementation known in the art. The user devices 331 and/or the networked system elements 335 may be coupled to the controller 315 through one or more networks 333 (e.g., a combination of cellular and Internet connections) so that not all user devices 331 and/or the networked system elements 335 may be coupled to the controller 315 through the same network 333 at the same time. One or more of the user devices 331 and the controller 315 may be connected to the network 333 in a wireless fashion. In one non-limiting embodiment, the network 333 is the Internet and one or more of the user devices 331 execute a user interface application (e.g. a web browser) to contact the controller 315 through the network 333.

As discussed above, embodiments provided herein are directed to apparatuses, systems, and methods for controlling electronic shutters and generating confirmation messages or indicators to confirm that an electronic shutter has appropriately responded to an instruction. In some embodiments, an instruction/command and/or confirmation indicator can be communicated over one or more lines, connections, or networks, such as network 333, e.g., a message or command made by a user device 331 and transmitted through the network 333 to the controller 315 to request a desired operation, function, etc. The transmission from the user device 331 may be initiated by a mobile device controlled by and/or associated with a specific user in a passive or active manner. In some embodiments, the mobile user device may be operative in conjunction with a Transmission Control Protocol (TCP) and/or a User Datagram Protocol (UDP). In some embodiments, the user device communication can be authenticated or validated based on a location of the user device.

As provided herein, the controller 315 can be associated with a command and confirm shutter system and/or a shutter control system as described above. The controller 315 can be used to process or fulfill the requests for system operation that are submitted from one or more user devices 331. The requests for system operation can be received through the network 333 from the one or more user devices 331 and/or the networked system elements 335, which may be mobile devices, including, but not limited to, phones, laptops, tablets, smartwatches, etc. One or more of the user devices 331 may be associated with (e.g., owned by) a particular user. The user may use his/her user device(s) 331 to request system operation in accordance with embodiments of the present disclosure.

For example, a user of a user device 331 can request service in an affirmative or active manner. The user may enter a request for system operation (at or by the controller 315) using an input/output (“I/O”) interface of the user device 331. That is, in some embodiments, an application, app, or other program that is installed and operated on the user device 331 can be employed to enable the user to interact with the app or program to request system operation at the controller 315.

In some embodiments, or in combination with active operation systems, a user device may request system operation in a passive manner. For example, a profile may be established for the user or the particular user device 331, optionally as part of a registration process with, e.g., a service provider, through historical data tracking, preset conditions, etc. The profile may contain a log of the user's history and/or activities, the user's preferences, or any other data that may be applicable to the user.

The request for system operation may be conveyed or transmitted from the user device 331 through the network 333. For example, the request for system operation can be transmitted to and/or over the Internet and/or a cellular network. The network(s) 333 may include infrastructure that may be organized to facilitate cloud computing. For example, one or more servers, such as a primary message server, a backup message server, and a device commissioning message server may be employed as part of the network 333.

In some embodiments, the request for system operation may specify a type of operation requested, at any level of detail or abstraction. For example, a first request for system operation may specify a close shutter operation, a second request for system operation may specify the specific shutters to be instructed to perform the close shutter operation, and a third request for system operation may specify a user defined confirmation time period. In some embodiments, the request for system operation transmitted from the user device 331 may include an identifier associated with the user or the particular user device 331 in order to allow the controller 315 to distinguish between various users and/or user devices 331.

Referring now to FIGS. 4A-4B, schematic block diagram illustrations of example computing systems 437a, 437b representing a user device 431 and a controller 415, respectively, are shown. The computing system 437a may be representative of computing elements or components of user devices, networked system elements, mobile devices, etc. as employed in embodiments of the present disclosure (e.g., user devices 331 and/or networked system elements 335 shown in FIG. 3). The computing system 437b may be representative of computing elements or components of controllers, controller, networked system elements, computers, etc. For example, the computing system 437a can be configured as part of a user device 431, e.g., user device 331 shown above. The computing system 437a can be configured to operate the user device 431, including, but not limited to, operating and controlling a touch-screen display to display various output(s) and receive various input(s) from a user's interaction with the touch-screen display. The computing system 437b can be configured as part of a controller, e.g., controller 315 shown above. The computing system 437b can be a computer or other type of controller that is physically connected or remote from various other elements of the systems described herein. The computing system 437b may be connected to various elements and components within a building that are associated with operation of embodiments of the present disclosure.

As shown, the computing system 437a includes a memory 439a which may store executable instructions and/or data. The executable instructions may be stored or organized in any manner and at any level of abstraction, such as in connection with one or more applications, apps, programs, processes, routines, procedures, methods, etc. As an example, at least a portion of the instructions are shown in FIG. 4A as being associated with one or more programs 441a. The memory 439a can include RAM and/or ROM and can store one or more programs 441a thereon, wherein the program(s) 441a may be a mobile operating system and/or mobile applications to be used on the user device 431.

Further, the memory 439a may store data 443a. The data 443a may include profile or registration data (e.g., in a user device), a device identifier, or any other type(s) of data. The executable instructions stored in the memory 439a may be executed by one or more processors, such as a processor 445a, which may be a mobile processor in the user device 431. The processor 445a may be operative on the data 443a and/or configured to execute the program 441a. In some embodiments, the executable instructions can be performed using a combination of the processor 445a and remote resources (e.g., data and/or programs stored in the cloud (e.g., remote servers)).

The processor 445a may be coupled to one or more input/output (I/O) devices 447a. In some embodiments, the I/O device(s) 447a may include one or more of a physical keyboard or keypad, a touchscreen or touch panel, a display screen, a microphone, a speaker, a mouse, a button, e.g., parts or features of a telephone or mobile device (e.g., a smartphone). For example, the I/O device(s) 447a may be configured to provide an interface to allow a user to interact with the user device 431. In some embodiments, the I/O device(s) 447a may support a graphical user interface (GUI) and/or voice-to-text capabilities for the user device 431.

The components of the computing system 437a may be operably and/or communicably connected by one or more buses. The computing system 437a may further include other features or components as known in the art. For example, the computing system 437a may include one or more communication modules 449a, e.g., transceivers and/or devices configured to receive information or data from sources external to the computing system 437a. In one non-limiting embodiments, the communication modules 449a of the user device 431 can include a near-field communication chip (e.g., Bluetooth®, Wi-Fi, etc.) and a cellular data chip, as known in the art. In some embodiments, the computing system 437a may be configured to receive information over a network (wired or wireless), such as network 333 shown in FIG. 3. The information received over the network may be stored in the memory 439a (e.g., as data 443a) and/or may be processed and/or employed by one or more programs or applications (e.g., program 441a).

The computing systems 437a may be used to execute or perform embodiments and/or processes described herein, such as within and/or on user devices. For example, the computing system 437a of the user device 431 enables a user interface to enable a user to make system operation requests related to a controller 415 or other system component. To make such system operation requests, the user device 431, and the computing system 437a thereof, may communicate with the computing system 437b of the controller 415.

For example, as shown in FIG. 4B, the controller 415 includes a computing system 437b that is used to receive commands and/or instructions (e.g., data) from remote devices, including, but not limited to, the user device 431. The computing system 437b is configured to control operation of systems and/or components associated with embodiments of the present disclosure. The computing system 437b (and program 441b stored thereon) may be configured to process requests for system operation received from one or more user devices (e.g., user device 431). As part of the processing, the computing system 437b may validate or authenticate the user device 437 such that only certain user devices 431 may be able to communicate and/or make system operation requests to the controller 415.

As shown, the computing system 437b of the controller 415 includes components similar to that shown and described with respect to the computing system 437a of FIG. 4A. As such, the controller computing system 437b includes a memory 439b with at least one program 441b and data 443b stored thereon. The data 443b may include profile or registration data (e.g., related to user devices), system component/element data, system control data and/or programs, or any other type(s) of data associated with control and/or operation as described herein. A processor 445b is configured to receive system operation requests through a communication module 449b from one or more user devices 431. The computing system 437b further includes one or more I/O devices 447b, including, but not limited to, control connections to one or more control elements of embodiments of the present disclosure. Further, in some configurations, the I/O devices 447b can include a monitor or display screen as part of a user interactive computing system that is associated with the system and/or controller 415.

Turning now to FIG. 5, a flow process 500 in accordance with an embodiment of the present disclosure is shown. The flow process 500 can be performed using one or more of the above described components and can be part of a command and confirm shutter system having elements as described above.

At block 502, a command and confirm shutter system processor receives instructions to perform an operation with one or more electronic shutters of the system (e.g., change a state or check on a current state). The instructions can be received through a network connection (either local or otherwise). In some embodiments, the instructions can be received from a remote user device, as described above. The instructions can be an indication of a desired state position of the one or more electronic shutters. For example, the instructions can indicate that the one or more electronic shutters should be closed, such as in advance of a storm that will be present at the property. The state of the electronic shutters can be “open,” “closed,” or a position therebetween. In some embodiments, a percentage of open or closed can be indicated in the instructions, such that a user can indicate that the electronic shutters should be partially opened or partially closed. The instructions can further indicate specific electronic shutters, individually, as subgroups, and/or all connected electronic shutters. For example, a subgroup can be all electronic shutters facing a specific compass direction (e.g., all east-facing shutters).

At block 504, the processor transmits a state command to the one or more electronic shutters. The transmission from the processor to the one or more electronic shutters can be wired or wireless communication, as described above. The state command can include a command to change state if a desired state is not currently in existence or to check if the desired state already exists.

At block 506, the processor can start a timer to wait a predetermined wait time. As will be appreciated by those of skill in the art, blocks 504, 506 can be performed simultaneously or nearly simultaneously such that the transmission of the state command starts the timer. The predetermined wait time can be preset based, in part, on a time required for an electronic shutter to perform a state change. For example, if it takes about 15 seconds for an electronic shutter to fully open from a closed position, the predetermined wait time can be a time that is equal to or greater than the operational time, to thus ensure sufficient time to allow the electronic shutter to perform the instructed action.

At block 508, the processor is configured to check to determine is an associated sensor detection signal matches the state command transmitted at block 504. For example, in some embodiments, the processor can send a request to a sensor detector associated with the one or more shutters and request a detected state (e.g., open, closed, etc.). The sensor detector can then transmit a status signal to the processor. In some instances, for example, the electronic shutter may already be in the requested position, and thus no change of status will actually occur. In some embodiments, when the sensor detector detects a change in state of the associated electronic shutter, the sensor detector can automatically transmit a signal to the processor to indicate the changed state. However, if an electronic shutter does not operate as instructed, such automatic signal generation may never occur, and thus the timer process described herein enabled detection and indication of failed operations.

At block 510, if the sensor detection matches the requested state, then the system will know that the electronic shutter is located in the correct (requested) state, and a state successful message can be generated. The successful state message is then transmitted to the requesting device (or other desired location) at block 512.

However, at block 514, if the sensor detection does not match the requested state, then the system will know that the electronic shutter failed to move to the requested state, and a state failure message can be generated. The failed state message is then transmitted to the requesting device (or other desired location) at block 516.

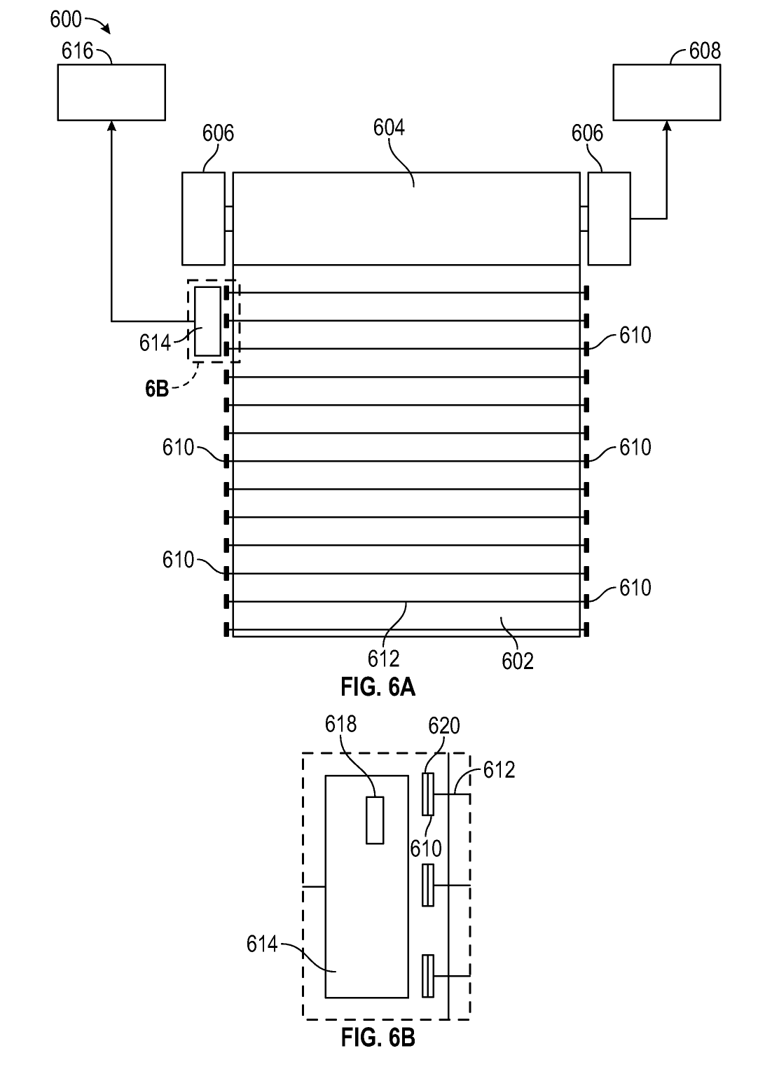

Turning now to FIGS. 6A-6B, schematic illustrations of an electronic shutter system 600 in accordance with an embodiment of the present disclosure is shown. The electronic shutter system 600 can be employed in one or more of the above described embodiments. Although a specific arrangement and configuration of the electronic shutter system 600 is shown in FIGS. 6A-6B, those of skill in the art will appreciate that variations thereon and/or other alternatives may be employed without departing from the scope of the present disclosure. FIG. 6B is an enlarged illustration of a shutter sensor shown in FIG. 6A, and indicated in the box 6B labeled in FIG. 6A.

As shown in FIG. 6A, the electronic shutter system 600 has a shutter 602 that is extendable from a head rail 604. The shutter 602 can be rolled within the head rail 604. A roller assembly 606 is provided to drive the shutter 602 into and out of the head rail 604 (e.g., wind/unwind about a roller). The roller assembly 606 is electrically powered by a power source 608, with at least one of the roller assembly 606 or the power source 608 in communication with a controller and/or processor as described above. The shutter 602 is movable along a plurality of roller guides 610 which can run within a track or other system along a window. The roller guides 610 can be mounted on ends of retaining shafts 612 which can also provide support and rigidity to the shutter 602.

The electronic shutter system 600 includes a shutter sensor 614 positioned relative to the shutter 602. The shutter sensor 614 is in communication with a sensor detector 616. As noted above, in some embodiments, the shutter sensor 614 and the sensor detector 616 can be a single unit or device. At least one of the shutter sensor 614 and the sensor detector 616 is in communication with a controller and/or processor as described above. The shutter sensor 614 is configured to detect a feature of the shutter 602 or a characteristic thereof. For example, as shown in FIG. 6B, the shutter sensor 614 can include a first switching element 618. A second switching element 620 is fixedly connected to a roller guide 610 of the shutter 602. When the first and second switching elements 618, 620 are aligned, the shutter sensor indicate that the shutter 602 is in a position for such alignment.

For example, a dry contact, normally-open switch (shutter sensor 614 including first switching element 618) can be installed per shutter 602 and activated by a rare-earth magnet (second switching element 620) attached permanently to the roller guide 610 at a location adjusted to the fully closed position of the shutter 602. The first switching element 618 is physically wired to the sensor detector 616 which can convert a dry contact, no-voltage closure and translate it into a signal or command that the processor of the command and confirm shutter system can understand. In some embodiments, shutter sensor 614 can include or have a physical address with associated or related information stored on or with the processor. Accordingly, the processor can determine which shutter is responding to the sent command.

Although described with respect to a magnetic configuration, those of skill in the art will appreciate that the shutter sensor can take various forms. For example, optical, mechanical, electronic, electrical, electromagnetic, etc. can be employed without departing from the scope of the present disclosure. Further, although shown in FIG. 6 with the second switching element 620 located to indicate a fully closed position of the shutter 602, other embodiments are possible without departing from the scope of the present disclosure. For example, in some embodiments, the shutter sensor and/or the switching elements 618, 620 can be arranged to indicate a fully open status or state of the shutter 602. Further, in some embodiments, multiple switching elements can be employed to provide additional information, such as a percentage of open/closed state.

Accordingly, embodiments provided herein may provide for a perimeter style security system, providing security against home invasion, extreme weather, or similar events. Embodiments enable user to have knowledge regarding a shutter system and whether one or more shutters have deployed and closed, thus providing the user with knowledge regarding security of a perimeter (e.g., windows or other portals having such shutters). In accordance with some embodiments as described herein, a shutter sensor and signal switch, that provides full-closure information to a control system, is installed inside the headrail of a window to protect the shutter sensor and signal switch from harsh environments and tampering. As described above, electronic shutter systems of the present disclosure can be controlled and monitored both onsite and offsite, such as, but not limited to, by smartphone, tablet, computer, or other similar communication devices.

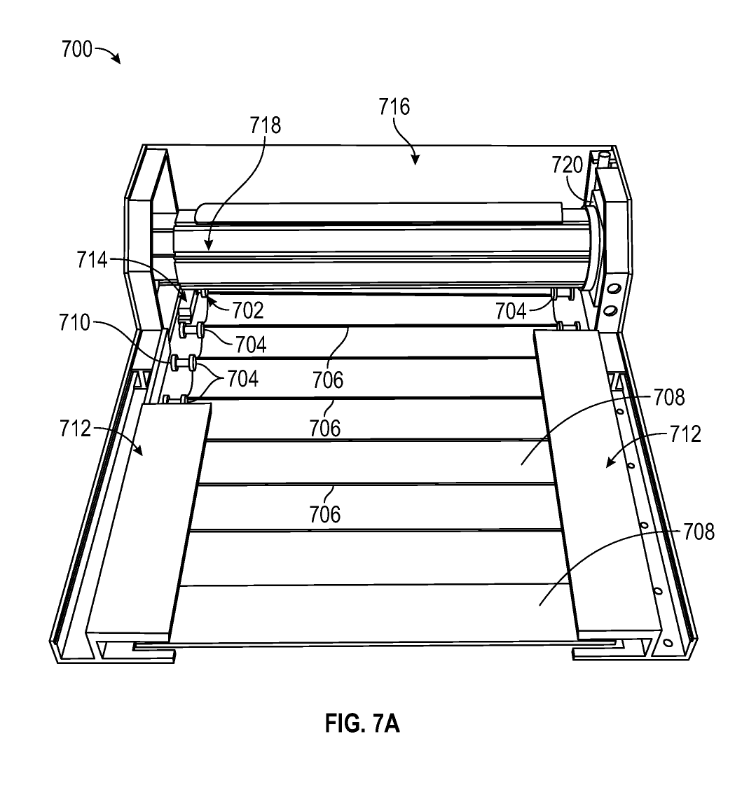

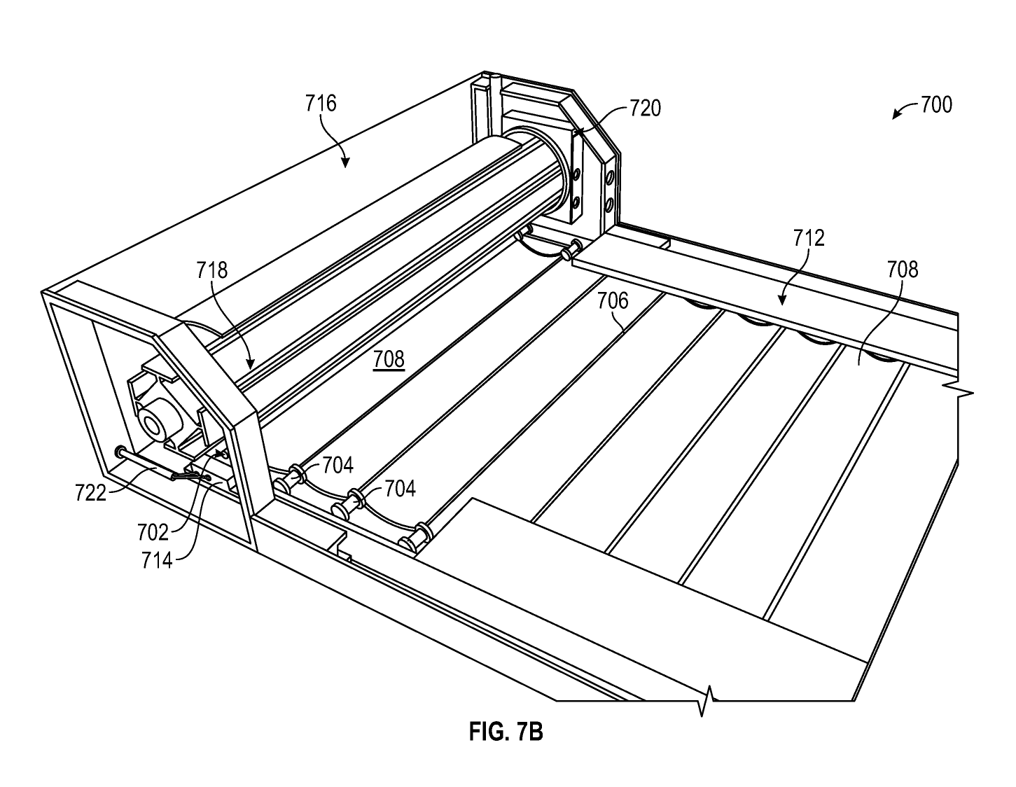

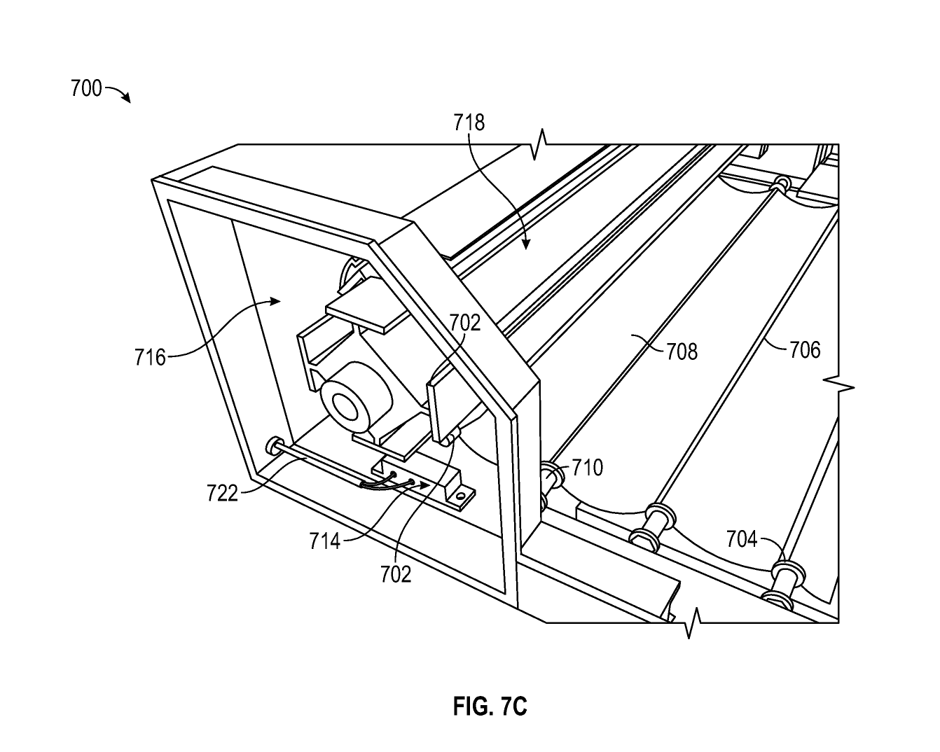

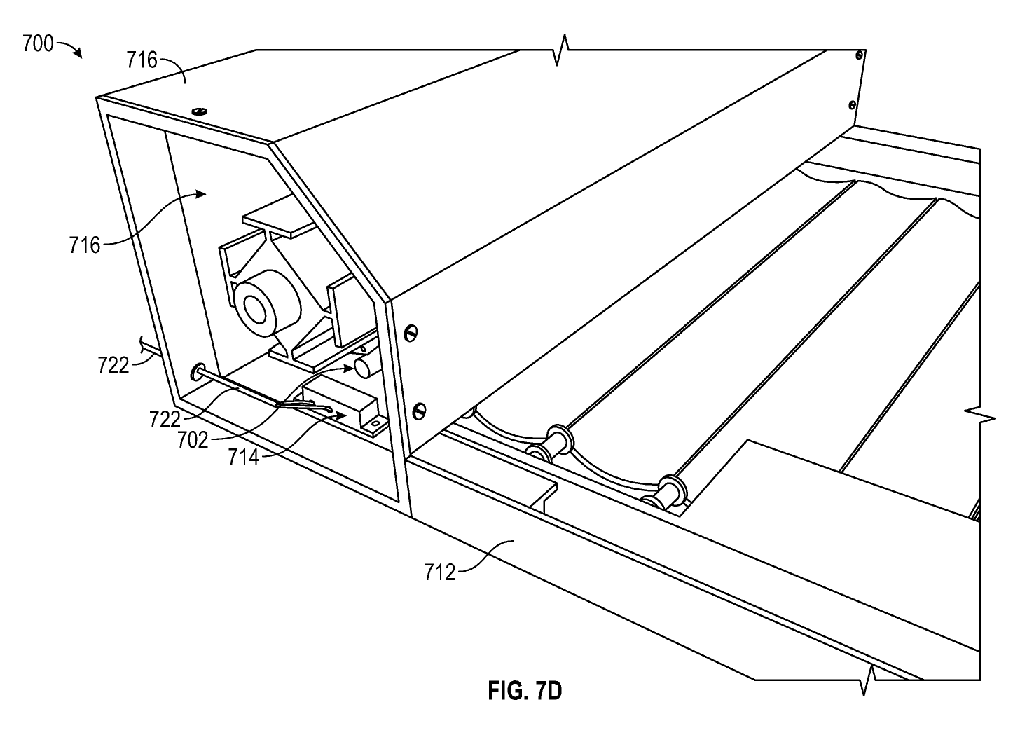

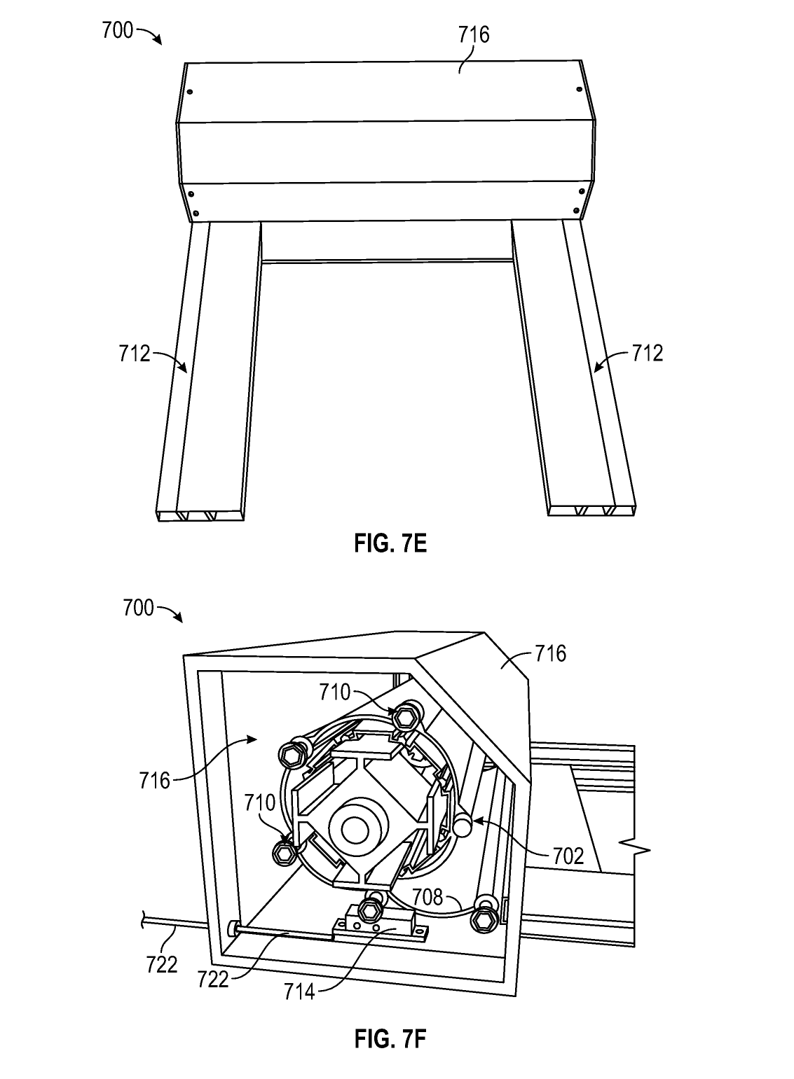

Turning now to FIGS. 7A-7F, schematic illustrations of an electronic shutter system 700 in accordance with an embodiment of the present disclosure are shown. FIG. 7A is a schematic illustration of the electronic shutter system 700 in a deployed state, with a partial internal view of components thereof. FIG. 7B is an alternative view of the electronic shutter system 700 shown in the deployed state. FIG. 7C is an enlarged illustration of a portion of the electronic shutter system 700 in the deployed state. FIG. 7D is another illustration of a portion of the electronic shutter system 700 in the deployed state. FIG. 7E is a schematic illustration of the electronic shutter system 700 in a retracted or stowed state. FIG. 7F is an enlarged illustration of a portion of the electronic shutter system 700 in the retracted state.

As shown, the electronic shutter system 700 employs a permanent magnet 702 (e.g., rare-earth magnet) mounted on one end roller 704 of a retaining shaft 706. A plurality of retaining shafts 706 provide support and rigidity to shutter panels 708 (e.g., panels, slats, blades, vanes, etc.). As noted, the permanent magnet 702 is mounted on one end roller 704 of the electronic shutter system 700, on the ends of the other end rollers 704 are roller guides 710 which are mounted on ends of retaining shafts 706 and are arranged to run within a guide track 712. The permanent magnet 702 is arranged to interact with, actuator, or otherwise trigger a signal when in proximity to a signal switch 714. The signal switch 714 is mounted within a headrail or housing 716 of the electronic shutter system 700. The shutter panels 708 are operably mounted to a drive tube 718 which is driven by a motor 720. The motor 720, the drive tube 718, and the shutter panels 708, when in the retracted or stowed state, are housed within the housing 716.

The shutter panels 708 are arranged in a nested arrangement when in the stowed state, with the shutter panels 708 wrapped or nested about the drive tube 718. In operation, the motor 720 will drive or rotate the drive tube 718 to either unwind (deploy) or wind (retract) the shutter panels 708. As the drive tube 718 is rotated, the roller guides 710 move into the guide track 712. In some embodiments, the roller guides 710, guide track 712 engagement, and shutter panels 708 are configured to withstand 200-mph wind forces and/or the force of an impact from a sledge hammer or similar object.

The signal switch 714 is positioned in the area where the rollers guides 710 travel, and thus is arranged adjacent the roller guides 710 as the roller guides 710 are moved within the electronic shutter system 700. A retaining shaft 706 that is located close to the top of the electronic shutter system 700 (when in the deployed state) includes the permanent magnet 702 attached or mounted thereto. Because of this arrangement, the permanent magnet 702 will only move into proximity of the signal switch 714 when all of shutter panels 708 are deployed (e.g., only upon full deployment of the electronic shutter system 700).

The permanent magnet 702 and/or the signal switch 714 are adjusted or positioned based on the specific arrangement of the electronic shutter system to enable interaction of the permanent magnet 702 with the signal switch 714 when the electronic shutter system 700 fully deployed, and thus the shutter is fully closed and protecting a window. In some embodiments, the permanent magnet 702 is fixedly and permanently mounted to a respective end roller 704. In some embodiments, the signal switch 714 is mounted in the housing 716 to avoid tampering and being compromised by weather or human interference.

The signal switch 714 can include a closure or switch housing that protects an internal magnet or other element that is responsive to the presence of the permanent magnet 702 being in proximity thereto. It will be appreciated that the switch housing is mechanical and absolute due to the control style, unlike a photometric sensing system which may be more easily compromised. In one non-limiting embodiment, the actuation of the signal switch 714 is a non-voltage type actuation mechanism that provides closure only. Closure of the signal switch 714, when the permanent magnet 702 is in proximity thereto, generates a low current signal. Such low current signal switches may be rated for operation at, for example, −15° F. to +160° F., 0.5 Amps, 100 VDC/VAC, and rated for a 1 inch gap allowed for spacing to the permanent magnet 702.

In accordance with embodiments of the present disclosure, false “close” readings are avoided by the shutter design and simplicity of the switching system. This is achieved because the permanent magnet 702 can only pass the signal switch 714 if the shutter system is fully deployed, and thus the retaining shaft 706 having the permanent magnet 702 is moved into proximity with the signal switch.

In operation, the motor 720 is in communication with a network, as described above. The network can be wired or wireless and may be local or internet based. A user device can be used to communicate with the motor 720 to enable control (e.g., opening or closing) of the electronic shutter system 700.

When a command is sent to close the shutter panels 708 to protect a window (e.g., a deploy command), the motor 720 is operated to rotate the drive tube 718 and thus deploy the shutter panels 708. When the deploy command is received at the motor 720, the shutter panels 708 are deployed. In some embodiments, the deploy command may be received a local processing or computing system (e.g., computing system 437b shown and described above). The computing system may be housed within the housing 716 or may be remote from the components housed in the housing 716 but operably couple thereto and/or in communication therewith, and employ a state command as described with respect to FIG. 5.

When the state command (or other control signal) is received at the motor 720, the motor 720 is operated to deploy the shutter panels 708. A timeout or wait period is performed at the computing system to allow for full deployment of the shutter panels 708. If the closure is completed in the given time, a signal will be generated by the signal switch 714 when the permanent magnet 702 is positioned in proximity to the signal switch 714. The signal switch 714 will generate a closure signal which may be transmitted to the computing system through a switch line 722. When the closure signal from the signal switch 714 is received, a “shutter is closed” message may be sent to a user or remote device, as described above. However, if the wait period expires with a closure signal being received at the computing system, a warning message may be delivered to the user or remote device, indicating that a shutter has failed to close. In some embodiments, as described above, the failure to close message may include information identifying a specific shutter to indicate which shutter of a system has failed to fully deploy.

For example, if the motor 720 is operated to move the shutter panels 708 into the down position and an obstruction stops the roller guides 710, the motor 720 will stop, e.g., due to resistance applied, as will be appreciated by those of skill in the art. The stopping of the motor 720 prior to full deployment will prevent the permanent magnet 702 from moving into proximity with the signal switch 714. The close tolerance of the end retention rollers in the side rails will not allow the shutter to “unroll” in the head rail and create a false reading. For example, the shutter panels 708 may be arranged in an interlocked manner (e.g., such as safety or security shutters) and the roller guides 710 have a high resistance to pressure applied to the roller guides 710 and the shutter panels 708. The guide track 712 and the roller guides 710, along with the rigidity of the shutter panels 708, do not allow for the shutter to “track” in the side rails.

Advantageously, systems as provided herein enable the generation and supply of knowledge regarding a full closure when a shutter is deployed (or lack of full closure). The location and style of the permanent magnetic and signal switch in the housing, combined with the full communication of the event to the end user, provides robust confirmation of remote and/or electronic operation of shutters.

Advantageously, embodiments described herein provide command and confirmation systems for electronic shutter operation. Advantageously, embodiments provided herein can enable a user to remotely activate and control shutters on a building. Further, embodiments provided herein can enable a user to know quickly if an instructed shutter has appropriately operated (e.g., successful open or close operation). The confirm response provided by embodiments of the present disclosure can insure that the structure and contents are protected by closed shutters, providing both protection and peace of mind to a user of such systems. Furthermore, any malfunction(s) of a shutter of a system configured in accordance with embodiments of the present disclosure can be automatically identified and reported to a user of the system, thus enabling a user to address a malfunctioning shutter before any further problems may arise (e.g., hurricane or other storm). Advantageously, the shutter command and confirmation systems of the present disclosure can be preinstalled and configured with manufactured windows. However, in some embodiments, the shutter command and confirmation systems of the present disclosure can be retrofit into existing structures.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. An electronic shutter system comprising:
an electronic shutter comprising a plurality of shutter panels housed within a housing;
a shutter controller configured in communication with the electronic shutter and configured to receive instructions from one or more user devices; and
a shutter sensor located within the housing and associated with the electronic shutter and configured to detect a state of the electronic shutter, wherein the shutter sensor is in communication with the shutter controller,
wherein the shutter controller is configured to:
transmit a state command to the electronic shutter upon receiving instructions from a user device,
start a timer upon transmitting the state command,
determine if the state of the electronic shutter matches the state command at expiration of the timer,
generate a state failure message when the state does not match the state command, and
transmit the state failure message to the user device.

2. The electronic shutter system of claim 1, wherein the shutter sensor comprises a first switching element located proximate the electronic shutter and a second switching element fixed to the electronic shutter and movable therewith, wherein when the second switching element is in proximity to the first switching element, a signal is generated.

3. The electronic shutter system of claim 2, wherein the first and second switching elements are magnets.

4. The electronic shutter system of claim 1, wherein the electronic shutter is in wireless communication with the shutter controller.

5. The electronic shutter system of claim 1, wherein the shutter controller is further configured to generate a state success message when the state matches the state command and transmit the state success message to the user device.

6. A command and confirm shutter system comprising:
a first electronic shutter;
a second electronic shutter;
a shutter controller configured in communication with the first and second electronic shutters and configured to receive instructions from one or more user devices;
a first shutter sensor associated with the first electronic shutter and configured to detect a state of the first electronic shutter, wherein the first shutter sensor is in communication with the shutter controller; and
a second shutter sensor associated with the second electronic shutter and configured to detect a state of the second electronic shutter, wherein the second shutter sensor is in communication with the shutter controller,
wherein the shutter controller is configured to:
transmit a state command to at least one of the first and second electronic shutters upon receiving instructions from a user device,
start a timer upon transmitting the state command,
determine if the state of the respective electronic shutter matches the state command at expiration of the timer,
generate a state failure message when the state does not match the state command, and
transmit the state failure message to the user device.

7. The command and confirm shutter system of claim 6, wherein the first shutter sensor comprises a first switching element located proximate the electronic shutter and a second switching element fixed to the first electronic shutter and movable therewith, wherein when the second switching element is in proximity to the first switching element, a signal is generated.

8. The command and confirm shutter system of claim 7, wherein the first and second switching elements are magnets.

9. The command and confirm shutter system of claim 6, wherein the first electronic shutter is in wireless communication with the shutter controller and the second electronic shutter is in wired communication with the shutter controller.

10. The command and confirm shutter system of claim 6, wherein the shutter controller is further configured to generate a state success message when the state matches the state command and transmit the state success message to the user device.

11. The command and confirm shutter system of claim 6, further comprising a first power supply in electrical communication with the first electronic shutter and a second power supply in electrical communication with the second electronic shutter.

12. The command and confirm shutter system of claim 11, wherein the first power supply is a battery and the second power supply is grid power.

13. The command and confirm shutter system of claim 6, further comprising a user device configured to communicate with the shutter controller.

14. The command and confirm shutter system of claim 6, wherein the timer is based on a state change operation of at least one of the first and second electronic shutters.
